(19) United States
(12) Patent Application Publication
(10) Pub. No.: US 2005/0063587 A1
(43) Pub. Date: Mar. 24, 2005

(54) Presentation supporting system and image processing method for the same

(75) Inventors: Katsuhiro Nishiwaki, Chita-gun (JP); Naoto Makino, Nagoya (JP)

Correspondence Address: OSTROLENK FABER GERB & SOFFEN, 1180 AVENUE OF THE AMERICAS, NEW YORK, NY, 100368403, US

(73) Assignee: Elmo Company, Limited

(21) Appl. No.: 10/789,822

(22) Filed: Feb. 27, 2004

(30) Foreign Application Priority Data
Sep. 23, 2003 (JP) 2003-310846

(51) Int. Cl. G06T 9/00; H04N 1/64

(52) U.S. Cl. 382/166; 358/539

(57) ABSTRACT

The present invention is directed to a presentation supporting system with the improved picture quality at colored edges of a resulting image. The presentation supporting system of the invention includes: a data input generation module that converts input analog data of an image into digital data expressed in an RGB color space to generate RGB image data; a data processing module that compresses the generated RGB image data to G-R/B image data of a compressed data volume by elimination of an R component and B component among R, G, and B components included in the RGB image data of each pixel, with regard to every other pixels in a main scanning direction of the image; a storage module that has a data bus of a predetermined bus width and temporarily stores the compressed G-R/B image data via the data bus; a data conversion module that reads the G-R/B image data from the storage module and interpolates the eliminated R component and B component, so as to convert the G-R/B image data into reproduced RGB image data including all the R, G, and B components with regard to each pixel; and a data output module that outputs the reproduced RGB image data to the display device.

### BACKGROUND OF THE INVENTION

1. Technical Field

The present invention relates a presentation supporting system with the improved picture quality of RGB output images, as well as to an image processing method adopted in the presentation supporting system.

2. Description of the Related Art

As is known in the art, a presentation supporting system takes an image of an object (source material) like a printed matter or a three-dimensional object with an input device including a lens and an array of CCD elements and displays the image on a display device, such as a CRT or a projector. The presentation supporting system converts the image data for enhancement of the picture quality of the image data taken by the input device. This data conversion converts RGB image data expressed by three primary color components R (red), G (green), and B (blue) (that is, in an RGB color space) into YCbCr image data expressed by Y (luminance) and Cb and Cr (hue) (that is, in a YCbCr color space).

Decomposition of the R, G, and B components with regard to each pixel into the luminance data and the hue data enables the luminance and the hue to be processed separately. This relatively facilitates the contour correction and the color correction. The decomposed data goes through data compression, which reduces an information volume of only the hue data while keeping the luminance data intact (to make the ratio of Y:Cb:Cr equal to 4:2:2). This compression method gives the image data with relatively less deterioration of the picture quality, and reduces the required memory capacity for storage of the compressed YCbCr (4:2:2) image data. The compressed YCbCr (4:2:2) image data is subjected to a preset series of image processing, is reconverted into RGB image data, and is output to the CRT or another display device (see, for example, Japanese Patent Laid-Open Gazette No. 2003-178292).

### DISCLOSURE OF THE INVENTION

As the recent trend, the higher picture quality has been demanded for the presentation supporting system. The output image generated by the conventional technique, which compresses the RGB image data taken with a CCD camera to YCbCr (4:2:2) image data and reconverts the compressed YCbCr (4:2:2) image data into RGB image data, may, however, have remarkable deterioration of the picture quality. This is ascribed to the technique of lowering the accuracy of the hue data (Cb, Cr) to attain the compression of the RGB image data to the YCbCr (4:2:2) image data. Reconversion of the compressed YCbCr (4:2:2) image data with the lowered accuracy of the hue data into the RGB image data causes all the R, G, and B components to be significantly affected by the compression. Especially the hue data has drastic effects on the picture quality at colored edges of a resulting image. There is prominent deterioration of the picture quality at the colored edges of the resulting image: noise on the hue, for example, colored vertical crimp, is disadvantageously observed.

The object of the invention is thus to eliminate the drawbacks of the prior art technique and to provide a presentation supporting system with the improved picture quality at colored edges of a resulting image.

In order to attain at least part of the above and the other related objects, the present invention is directed to a presentation supporting system that inputs an image signal from a shooting device that takes a color image, processes the input image signal, and outputs the processed image signal to a display device. The presentation supporting system includes: a data input generation module that inputs the color image taken by the shooting device as analog data and converts the input analog data into digital data expressed in an RGB color space to generate RGB image data; a data processing module that compresses the generated RGB image data to G-R/B image data of a compressed data volume by elimination of an R component and B component among R, G, and B components included in the RGB image data of each pixel, with regard to every other pixels in a main scanning direction of the image; a storage module that has a data bus of a predetermined bus width and temporarily stores the compressed G-R/B image data via the data bus; a data conversion module that reads the G-R/B image data from the storage module and interpolates the eliminated R component and B component, so as to convert the G-R/B image data into reproduced RGB image data including all the R, G, and B components with regard to each pixel; and a data output module that outputs the reproduced RGB image data to the display device.

There is an image processing method corresponding to the presentation supporting system of the invention. The invention is accordingly directed to an image processing method adopted in a presentation supporting system that inputs an image signal from a shooting device that takes a color image, processes the input image signal, and outputs the processed image signal to a display device. The image processing method includes the steps of: inputting the color image taken by the shooting device as analog data and converting the input analog data into digital data expressed in an RGB color space to generate RGB image data; compressing the generated RGB image data to G-R/B image data of a compressed data volume by elimination of an R component and B component among R, G, and B components included in the RGB image data of each pixel, with regard to every other pixels in a main scanning direction of the image; temporarily storing the compressed G-R/B image data via a data bus of a predetermined bus width; reading the G-R/B image data from the storage and interpolating the eliminated R component and B component, so as to convert the G-R/B image data into reproduced RGB image data including all the R, G, and B components with regard to each pixel; and outputting the reproduced RGB image data to the display device.

In the presentation supporting system of the invention or the corresponding image processing method, each image taken by the shooting device is generated as the RGB image data including the R, G, and B components for each pixel, is compressed to the G-R/B image data by elimination of the R and B components with regard to every other pixels in the main scanning direction of the image, and is temporarily stored in the form of the compressed G-R/B image data. The G-R/B image data is read from the storage, goes through the interpolation of the eliminated R and B components with regard to the pixels having only the G component to be converted into the reproduced RGB image data, and is output to the display device. The interpolation for conversion into the reproduced RGB image data is carried out with regard to every other pixels in the main scanning direction having only the G component, while keeping the residual pixels unchanged. This arrangement desirably reduces the effects of the conversion for reproduction of the compressed data and thus prevents deterioration of the picture quality due to the conversion. Especially the arrangement of the invention significantly enhances the picture quality at colored edges of a resulting image, compared with the prior art technique of converting the YCbCr image data with the compressed information volume on the hue components into the RGB image data for reproduction. The storage of the image data in the compressed form desirably reduces the required capacity for data storage.

In one preferable application of the presentation supporting system of the invention, the predetermined bus width is (3+n)-th power of 2 bits, where n is an integer of not less than 1, and each of the R, G, and B components included in the RGB image data and in the G-R/B image data of each pixel is expressed as 8-bit data. The G-R/B image data is 16-bit image data in a minimum read-write unit, and the data conversion module receives and transmits the 16-bit image data in units of (n-1)-th power of 2 from and to the storage module via the data bus of the predetermined bus width.

The presentation supporting system of this application compresses the RGB image data, which has the R, G, and B components each expressed as 8-bit data, to the 16-bit G-R/B image data in the minimum unit and reads or writes the compressed 16-bit G-R/B image data from or into the storage module via the data bus. The data bus has a width of (3+n)-th power of 2 bits (n≧1) (that is, the bus width of 16, 32, 64, 128, . . . bits). The compressed 16-bit image data is accordingly transmitted in the unit of an integral number (that is, 1, 2, 4, 8, . . . ). This arrangement ensures the effective use of the bus width of the data bus. Especially when n is not less than 2, this arrangement effectively enhances the processing speed of the image data.

### BRIEF DESCRIPTION OF THE DRAWINGS

FIG. 1 is a perspective view showing the appearance of a presentation supporting system in one embodiment of the invention;

FIG. 2 is a functional block diagram showing image processing functions of the presentation supporting system;

FIG. 3 is a flowchart showing an image data compression routine to generate 16-bit data;

FIG. 4 is a flowchart showing an image data output routine to process image data for output; and

FIG. 5 shows the conversion of image data in a flow of input to output.

### BEST MODES OF CARRYING OUT THE INVENTION

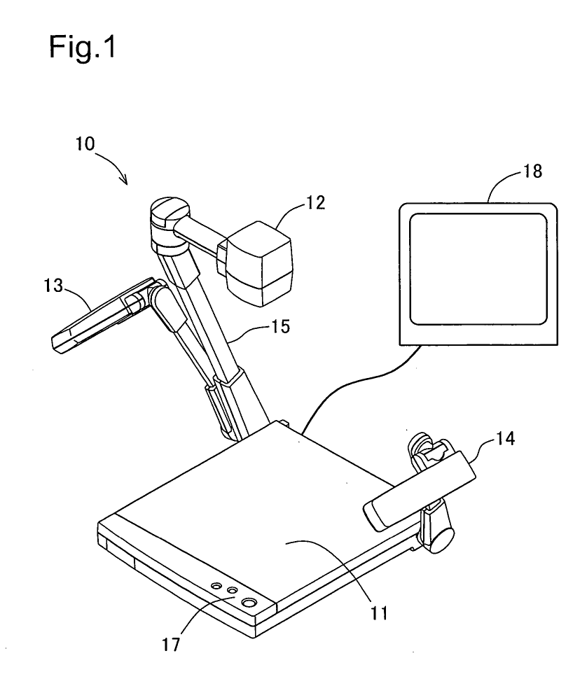

A presentation supporting system in one embodiment of the invention is discussed below. FIG. 1 is a perspective view showing the appearance of a presentation supporting system 10. As illustrated, this presentation supporting system 10 includes a stage 11 on which a source material or an object is placed, a camera head 12 for shooting the object, a movable camera arm 15 for holding the camera head 12 in a pivotally movable and rotatable manner, and left and right side lights 13 and 14 for illuminating the object.

The stage 11 has a quasi-rectangular shape and is equipped with the side lights 13 and 14 and the camera arm 15 to be foldable and extendable by rotations on one end and with an operation panel 17 on the other end. The camera head 12 is formed in a quasi-rectangular box shape and has a built-in shooting module including a lens and a CCD (charge coupled device) array with variable zoom magnification and white balance. The operation panel 17 has a power supply of the side lights 13 and 14 and various switches for adjusting the aperture diaphragm, the zoom magnification, and the white balance.

An object placed on the stage 11 of the presentation supporting system 10 is illuminated by the side lights 13 and 14 at the suitably adjusted positions according to the requirements and is shot by the camera head 12. The various switches in the operation panel 17 are manipulated, for example, to adjust the zoom magnification. The resulting image is output to a CRT 18 or another external display device like a projector connecting with the presentation supporting system 10.

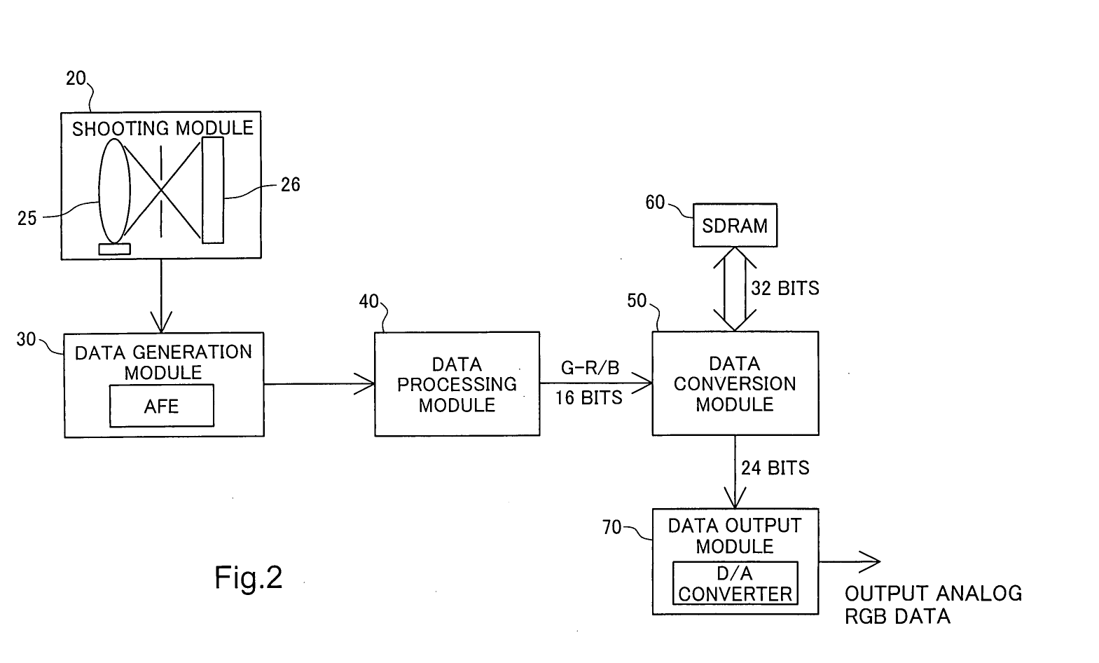

The internal structure of the presentation supporting system 10 is described below. FIG. 2 is a functional block diagram showing the image processing functions of the presentation supporting system 10. As illustrated, the presentation supporting system 10 mainly includes a built-in shooting module 20 included in the camera head 12, a data generation module 30 that generates digital image data from analog image data, a data processing module 40 that compresses the digital image data by a preset series of processing, a data conversion module 50 that receives and transmits data from and to a memory for storing the compressed data, and a data output module 70 that converts digital data into analog output data. This presentation supporting system 10 is capable of shooting a moving object at the rate of 20 frames per second.

The shooting module 20 has a lens 25 and a CCD array 26. The CCD array 26 includes multiple light-receiving elements (photo diodes) to hold charges according to the intensity of light entering via the lens 25 and outputs the electrical charges held by the photo diodes (in the form of analog electric signals). One of three color filters that respectively allow transmission of three primary colors, that is, R (red), G (green), and B (blue) color components, are allocated to each of the multiple photo diodes. Each photo diode detects one color component. The CCD array 26 outputs information on the color of an image in the form of electric signals from the photo diodes. The structure of this embodiment uses a single-plate-type 1CCD array of 800 thousand pixels, although a three-plate-type 3CCD array including photo diodes for the three primary colors with regard to each pixel may be used instead.

The data generation module 30 has an analog front end (hereafter referred to as AFE) including an A/D converter circuit and converts input electric signals (analog data) into digital data. The AFE has a CDS (correlated double sampling) circuit to eliminate part of the noise included in the output signals from the CCD array 26. The data generation module 30 receives inputs of analog data of the R, G, and B color components from the shooting module 20, activates the internal CDS circuit to eliminate part of the noise, and converts the analog data of each color component into 8-bit digital data. In the structure of this embodiment, the AFE has the resolution of outputting 10-bit digital data of the R, G, or B color component (that is, data with regard to each pixel) at the maximum.

The data processing module 40 includes an interpolation circuit, a contour correction circuit, and a color adjustment circuit and makes each input 8-bit digital data subjected to a series of data processing. The interpolation circuit of the data processing module 40 interpolates lacking information from adjoining pixels, since each input digital data has information regarding only one of the R, G, and B color components with respect to each pixel. The interpolation gives 24-bit RGB image data expressed in an RGB color space of 8 bits on each side with regard to each pixel. The contour correction circuit converts the RGB image data into YCbCr image data expressed in an YCbCr color space defined by luminance (Y) data and hue (Cb, Cr) data and independently processes only the luminance (Y) data for edge enhancement of the image. The color adjustment circuit independently process only the hue (Cb, Cr) data to adjust the color of the image.

The data processing module 40 re-converts the processed YCbCr image data into RGB image data. The original RGB image data prior to conversion has 24-bit information volume (8-bit data with regard to each of the three color components R, G, and B). The data processing module 40 compresses the information volume of the 24-bit RGB image data to 16-bit G-R/B image data. This compression process will be discussed later in detail.

The data conversion module 50 has an SDRAM (Synchronous Dynamic Random Access Memory) 60 to temporarily store image data and a data bus of a 32-bit width used for transmission of data to and from the SDRAM 60. The SDRAM 60 has a memory capacity equivalent to two image frames as two banks and switches over an active bank between the two banks at preset timings to read image data from one bank and write next image data into the other bank. The image data written into the SDRAM 60 is utilized in, for example, a ‘still image mode’ for displaying a preset one-frame image.

The data conversion module 50 successively reads the 16-bit G-R/B image data from the SDRAM 60 at preset timings and re-converts the input 16-bit G-R/B image data into 24-bit RGB image data. The conversion procedure interpolates image information eliminated in the process of compression to 16 bits, so as to reproduce 24-bit image data. The data conversion module 50 also converts the rate of frames displayed per second and converts the image at the rate of 20 frames per second into an image at the rate of 60 frames per second.

The data output module 70 having a D/A converter circuit converts the 24-bit RGB image data reproduced by the data conversion module 50 into analog RGB data and outputs the analog RGB data to the CRT 18. The output of the analog RGB data is high resolution output in conformity with the XGA (eXtended Graphics Array) display standard. The data output module 70 has a non-illustrated NTSC (National TV Standards Committee) conversion circuit, which converts the analog RGB data into NTSC data and thereby enables a resulting image to be displayed on a TV monitor.

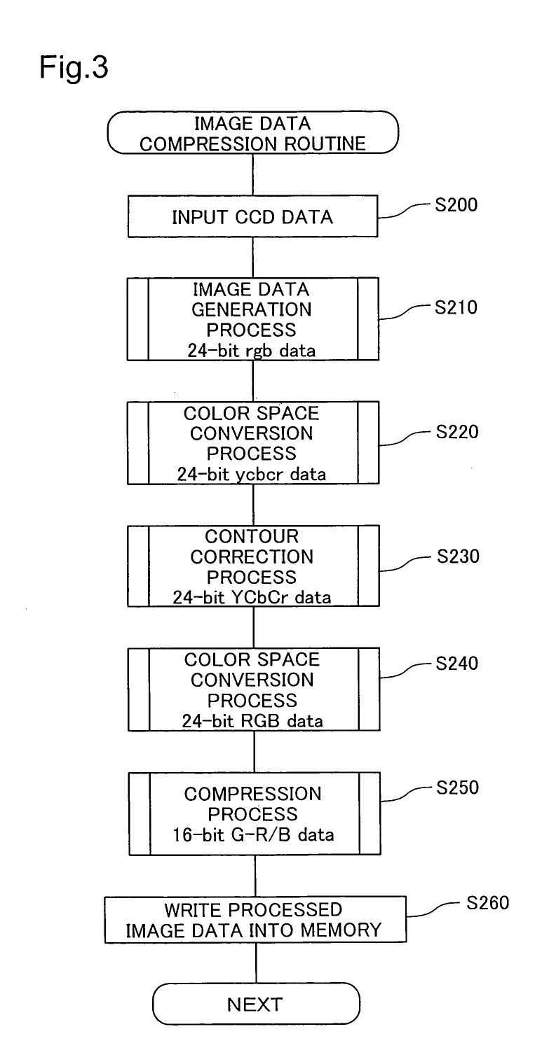

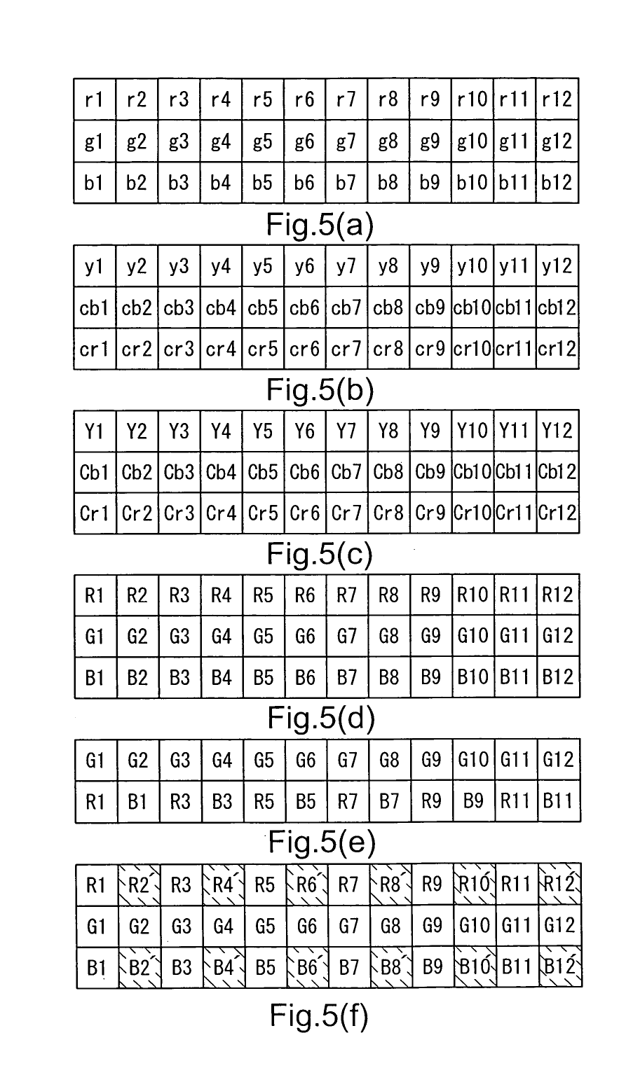

In the presentation supporting system 10 having these functional blocks, an image of an object (source material) to be displayed is taken by the shooting module 20, goes through the data generation module 30, and is compressed by the data processing module 40. The following describes the image data compression process in the data processing flow, mainly a series of data processing executed by the data processing module 40. FIG. 3 is a flowchart showing an image data compression routine that generates 16-bit data to be written into the SDRAM 60. FIG. 5 shows the conversion of image data in the flow of input to output. The structure of the image data converted by the processing flow of FIG. 3 is described according to the requirements.

An object image taken by the CCD array 26 of the shooting module 20 is output as analog electric signals (step S200). The analog electric signals are input via the data generation module 30 into the data processing module 40 to go through an image data generation process (step S210). The analog data input from the CCD array 26 goes through the noise elimination by the AFE of the data generation module 30, is converted into digital data by the data generation module 30, and is subjected to the interpolation by the data processing module 40. This generates 24-bit digital RGB image data.

The 24-bit RGB image data has R, G, and B color component data with regard to each pixel, as shown in FIG. 5(a). In the illustration of FIG. 5(a), each column (for example, a combination of r1, g1, and b1) represents one pixel, where the capacity of 8 bits is allocated to each of r1, g1, and b1. Each pixel is accordingly expressed by 24-bit image data.

The 24-bit RGB image data generated by the data processing module 40 is then subjected to a color space conversion process (step S220). The color space conversion process converts data in the RGB color space into data in the YCbCr color space. A known conversion matrix is used for this conversion and effectuates mutual conversion between the RGB image data and the YCbCr image data in a reversible manner. The conversion matrix converts, for example, r1, g1, b1 data into y1, cb1, cr1 data as shown in FIG. 5(b). The YCbCr image data at this stage is 24-bit data with regard to each pixel.

The converted YCbCr image data is subsequently subjected to a contour correction process (step S230). The contour correction process makes only the luminance component of each pixel subjected to frequency conversion to attain edge enhancement without affecting the hue components (without color distortion). Only the hue components may go through color adjustment according to the requirements. The resulting image data after the contour correction is shown in FIG. 5(c). In the illustration of FIG. 5(c), the luminance component is expressed as ‘Y’ and the hue components are expressed as ‘Cb’ and ‘Cr’.

The YCbCr image data obtained by the contour correction process is again subjected to the color space conversion process with the conversion matrix (step S240). Since the luminance component and the hue components have been corrected in the preceding step, the resulting image data after the color space conversion is different from the original RGB image data generated at step S210. Namely the correction of the luminance component and the hue components affects all the color components (R, G, B) through the color space conversion. The resulting image data is shown in FIG. 5(d). As illustrated, the r1, g1, and b1 components of the input image data go through the series of processing discussed above for the enhanced picture quality and are eventually converted into R1, G1, and B1 components. The data size of each pixel is unchanged through the data conversion from the state of FIG. 5(a) to the state of FIG. 5(d). The color space conversion process is reversible and thus does not deteriorate the quality of the image data.

The resulting R, G, and B components generated through the above series of processing are given as 24-bit image data. The 24-bit RGB image data is then subjected to a compression process (step S250). The compression process reduces the data volume of the R and B components, while keeping the data volume of the G component, with regard to all the pixels. This compresses the data volume of the image on the whole.

FIG. 5(e) shows the resulting image data after the compression process. The compression process from the state of FIG. 5(d) to the state of FIG. 5(e) deletes the R and B components with regard to pixels of even ordinal numbers. The compression process keeps all the component data (for example, R1, G1, and B1) without compression with regard to pixels of odd ordinal numbers, but keeps only the G component (for example, G2) while eliminating the other components (for example, R2 and B2) with regard to pixels of even ordinal numbers. The data corresponding to two adjoining pixels are accordingly 32-bit data of R1, G1, B1, and G2. Tentative division of this 32-bit data into a combination of (G1, R1) components for the first pixel and a combination of (G2, B1) components for the second pixel gives 16-bit image data (hereafter referred to as the G-R/B image data) with regard to each of the two pixels. The resulting compressed G-R/B image data is sequentially written into a specified bank of the SDRAM 60 via the data bus of the 32-bit width (step S260). This series of processing here goes to NEXT and is repeated at preset timings.

In general, the human eye is highly sensitive to the wavelength for green (the G component). The color filters allocated to the CCD array are accordingly arranged to have the largest information volume on the G component. This series of compression process compresses the data volume of the image by eliminating part of the data of the R and B components that have only little effects on the picture quality while not eliminating any data of the G component that significantly affects the picture quality and has the largest information volume. The resulting compressed image data is 16-bit data and is thus accessible in the unit of two by the data bus of the 32-bit width. Such compression desirably reduces the required storage capacity of the SDRAM 60 and enhances the processing speed, for example, the access speed to the SDRAM 60.

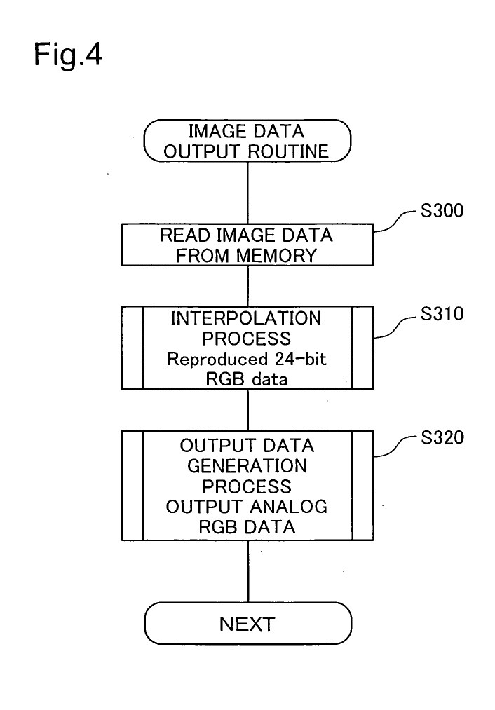

The image data written into the SDRAM 60 is read and is processed by the data conversion module 50 to be output to the display device like the CRT 18. The following describes the image data output process in the data processing flow, mainly a series of data processing executed by the data conversion module 50. FIG. 4 is a flowchart showing an image data output routine that processes the image data written in the SDRAM 60 for output.

The G-R/B image data written in the SDRAM 60 is read by the data conversion module 50 (step S300). The read-out image data is 16-bit image data as shown in FIG. 5(e).

An interpolation process is then carried out to convert the 16-bit image data into 24-bit image data for output (step S310). Any of various methods may be applied to the interpolation process. The procedure of this embodiment adopts a conventional interpolation technique. The procedure interpolates the lacking R and B components with regard to each pixel of an even ordinal number from the existing R and B components with regard to adjoining pixels of odd ordinal numbers for generation of 24-bit image data. As shown in FIG. 5(e), the 16-bit G-R/B image data has all the component data with regard to pixels of odd ordinal numbers, for example, the first pixel (R1, G1, B1) and the third pixel (R3, G3, B3). The lacking image data of the R2 component is assumed to be the average of the image data R1 and R3 of the adjoining pixels (½ interpolation). Similarly the lacking image data of the B2 component is assumed to be the average of the image data B1 and B3 of the adjoining pixels. This interpolation process converts the 16-bit G-R/B image data into 24-bit image data as shown in FIG. 5(f). In the illustration of FIG. 5(f), newly generated component data by the ½ interpolation technique are expressed as R′ and B′ for discrimination from the original component data R and B.

The resulting 24-bit image data is digital data. This digital data is subsequently converted into analog RGB data in the typical output form (step S320). The 24-bit digital data output from the data conversion module 50 is converted into analog data by the D/A converter circuit in the data output module 70. The analog RGB data is output from the data output module 70 to the CRT 18 or another external display device to display a resulting processed image. This series of processing goes to NEXT after step S320 and is repeated at preset timings.

The G-R/B image data read from the SDRAM 60 in the image data output process has the partial elimination of the R and B components, which have little effects on the picture quality. Generation of the lacking R and B component data by interpolation thus hardly deteriorate the picture quality of the resulting image. The typical procedure of YCbCr data compression eliminates part of the hue data (Cb, Cr). Conversion of the compressed YCbCr (4:2:2) data having the reduced information volume on the hue into RGB data by the color space conversion causes all the resulting R, G, and B component data to be significantly affected by the compression. The compression process of this embodiment, however, causes only the newly generated component data (for example, R2′, B2′) by the interpolation to be affected by the compression. The technique of the embodiment thus desirably improves the picture quality of the resulting image, compared with the prior art YCbCr (4:2:2) data compression technique. Especially the technique of the embodiment effectively prevents deterioration of the picture quality at colored edges of the image, which is remarkable in the prior art YCbCr (4:2:2) data compression technique.

The above embodiment regards the presentation supporting system 10 having the set of image processing functions to compress input RGB image data into G-R/B image data for storage and processing and re-convert G-R/B image data into RGB image data by interpolation for output. Such image processing functions may be divided into separate structures. One example is a system including an image processing device that execute the compression process (that is, generation of G-R/B image data) and a PC (personal computer) that has the functions of reconverting the compressed image data. In this system, the generated G-R/B image data is sent from the image processing device to the PC via a USB terminal and is stored in the PC. The G-R/B image data read from the storage is reconverted into RGB image data and is displayed on a CRT. The image data is in the compressed form of the G-R/B image data on the occasions of data transmission and access to a memory in the PC. This ensures the high-speed processing and reduction of the required storage capacity. Additionally this system improves the picture quality at the colored edges of the resulting image displayed on the CRT, compared with the prior art system of transmitting the YCbCr (4:2:2) image data.

The embodiment discussed above is to be considered in all aspects as illustrative and not restrictive. There may be many modifications, changes, and alterations without departing from the scope or spirit of the main characteristics of the present invention. For example, the compression process of the embodiment deletes the R and B components with regard to pixels of even ordinal numbers for the purpose of compression of image data. One modified procedure may alternately delete the R component or the B component among the R, G, and B components of each pixel. Such alternate deletion leaves a combination of the components (G1, R1) for the first pixel, a combination of the components (G2, B2) for the second pixel, and a combination of the components (G3, R3) for the third pixel. Another possible modification may delete the R and B components with regard to pixels of odd ordinal numbers.

1. A presentation supporting system that inputs an image signal, processes the input image signal, and outputs the processed image signal to a display device, said presentation supporting system comprising:
a shooting device that takes a color image;
a data input generation module that inputs the color image taken by the shooting device as analog data and converts the input analog data into digital data expressed in an RGB color space to generate RGB image data;
a data processing module that compresses the generated RGB image data to G-R/B image data of a compressed data volume by elimination of an R component and B component among R, G, and B components included in the RGB image data of each pixel, with regard to every other pixels in a main scanning direction of the image;
a storage module that has a data bus of a predetermined bus width and temporarily stores the compressed G-R/B image data via the data bus;
a data conversion module that reads the G-R/B image data from said storage module and interpolates the eliminated R component and B component, so as to convert the G-R/B image data into reproduced RGB image data including all the R, G, and B components with regard to each pixel; and
a data output module that outputs the reproduced RGB image data to the display device.

2. A presentation supporting system in accordance with claim 1, wherein the predetermined bus width is (3+n)-th power of 2 bits, where n is an integer of not less than 1,
each of the R, G, and B components included in the RGB image data and in the G-R/B image data with regard to each pixel is expressed as 8-bit data,
the G-R/B image data is 16-bit image data in a minimum read-write unit, and
said data conversion module receives and transmits the 16-bit image data in units of (n-1)-th power of 2 from and to said storage module via the data bus of the predetermined bus width.

3. An image processing method adopted in a presentation supporting system that inputs an image signal from a shooting device that takes a color image, processes the input image signal, and outputs the processed image signal to a display device, said image processing method comprising the steps of:
inputting the color image taken by the shooting device as analog data and converting the input analog data into digital data expressed in an RGB color space to generate RGB image data;
compressing the generated RGB image data to G-R/B image data of a compressed data volume by elimination of an R component and B component among R, G, and B components included in the RGB image data of each pixel, with regard to every other pixels in a main scanning direction of the image;
temporarily storing the compressed G-R/B image data via a data bus of a predetermined bus width;
reading the G-R/B image data from the storage and interpolating the eliminated R component and B component, so as to convert the G-R/B image data into reproduced RGB image data including all the R, G, and B components with regard to each pixel; and
outputting the reproduced RGB image data to the display device.
